(19) United States
(12) Patent Application Publication
(10) Pub. No.: US 2013/0060791 A1
(43) Pub. Date: Mar. 7, 2013

(54) METHOD AND SYSTEM FOR INFORMATION MANAGEMENT WITH FEED AGGREGATION

(71) Applicants: Richard Szalwinski, Westmount (CA); Juan Pablo Di Lelle, Montreal (CA); Julien St-Laurent, Montreal (CA); Matthew Milan, Toronto (CA); Ayla Newhouse, Toronto (CA); John McArdle, Toronto (CA)

(72) Inventors: Richard Szalwinski, Westmount (CA); Juan Pablo Di Lelle, Montreal (CA); Julien St-Laurent, Montreal (CA); Matthew Milan, Toronto (CA); Ayla Newhouse, Toronto (CA); John McArdle, Toronto (CA)

(73) Assignee: Spundge inc., Montreal (CA)

(21) Appl. No.: 13/605,782

(22) Filed: Sep. 6, 2012

Related U.S. Application Data
(60) Provisional application No. 61/531,564, filed on Sep. 6, 2011.

(51) Int. Cl. G06F 17/30

(52) U.S. Cl. 707/754; 707/E17.116

(57) ABSTRACT

The present document describes a system and method for managing electronic information. The system may receive a search topic from the user and optionally a set of filter parameters e.g search keywords, information sources, time etc. The system may then collect information about the search topic from at least one remote information source over the communication network. The collected information is then filtered in accordance with the filter parameters and packaged in discrete information containers. The discrete information containers may then be sent to the remote user device for display.

### CROSS-REFERENCE TO RELATED APPLICATIONS

This application claims priority of U.S. provisional patent application 61/531,564 filed on Sep. 6, 2011. The specification is hereby incorporated by reference in their entirety.

### BACKGROUND

(a) Field

The subject matter disclosed generally relates to the field of electronic information management; more specifically it relates to the aggregation, organization, display and use of disparate electronic information feeds to create electronic notebooks and user generated content.

(b) Related Prior Art

There are many news aggregation sites on the web which collect, organize and display news feeds from around the world. These sites specialize in making syndicated web content such as news articles, blogs, vlogs and podcasts from around the world available to the general public in a single web location. The content is displayed as links to the original content and users navigate through the links to view the content that interests them. While these links to content can be saved or bookmarked, there lacks a simple and intuitive method for the viewer to collect, save and organize the content itself within an integrated search system.

On the other hand, many sites on the internet offer news or information feeds in the form of RSS feeds or something similar. These sites are sources of information which broadcast copious amounts of information on a daily basis. What is needed is a system to collect, filter, organize and display these disparate feed formats in one platform.

Furthermore, while current aggregation sites allow users to add comments to content, the commenting is not targeted because it is not tied to a specific location such as a word or a phrase. Rather, the comments appear in batch format at the end of the story in a disjointed way. There is a need for a more targeted commenting method where comments and debates can be localized to certain parts of the text while at the same time remaining unobtrusive.

While current news aggregation sites allow for commenting and sharing of stories via email or twitter or the like, they don't offer the ability for a user to truly get into the discussion by writing their own story. Current sites are mostly a one way funnel of information towards the user, so there lacks a method and a system for users to aggregate information and create their own story and upload that story for other users to see. Furthermore, there is no oversight or editing of user generated content. What is needed is a system that includes information aggregation and that allows a user to easily create a story and upload it for either general viewing or to be edited and verified by professionals. The editing of the user generated content via professionals makes these stories more valuable and relevant because of the validation. What is also lacking is an automated way to add references to this user generated content when it contains content from another source. Similarly, within this system to generate user generated content there is a need of a method that can simply and directly allow the reader to view and verify the original source.

### SUMMARY

According to an embodiment, there is provided a method for managing electronic information, the method comprising: receiving, from a remote user device over a communication network, a first user input comprising a search topic; collecting electronic information about the search topic from at least one remote electronic information source over the communication network; packaging the collected information in discrete information containers; and sending the discrete information containers to the remote user device for display.

According to another embodiment, the method further comprises receiving a set of filter parameters, and filtering the collected electronic information using the set of filter parameters prior to packaging it.

According to a further embodiment, the set of filter parameters comprises one or more of: search keywords, time, information sources, geographical location, social engagement, and relevance to the topic.

According to yet another embodiment, the method further comprises storing the filtered electronic information in a database.

According to another embodiment, the method further comprises creating an empty notebook; and organizing the filtered electronic information related to the topic in the notebook.

According to yet another embodiment, the method further comprises abbreviating the filtered electronic information of each information container in an information bubble thereby resulting in a list of information bubbles.

According to a further embodiment, the method further comprises displaying the full content of the electronic information container upon detecting a pointing device clicking or moving over one of the information bubbles.

According to yet another embodiment, the method further comprises dividing a visual display of said notebook on a display device into at least two sections, one section defining a content stream including the filtered electronic information, and another section defining saved content that was selected from the content stream to be saved in the notebook.

According to another embodiment, the method further comprises embedding at least one of the content stream section and the saved content section into a website, whereby changes that occur in one of the sections in the notebook are reflected automatically in the website.

According to a further embodiment, the method further comprises receiving new collected information; filtering the newly collected electronic information to produce updated filtered information; storing the updated filtered information in the database; comparing the updated filtered information with information previously stored in the database to find electronic information duplicates; and eliminating electronic information duplicates from the database.

According to yet another embodiment, the filter parameters are received from one or more users in a collaborative environment, the users having access to a single pool of filtered electronic information, and having the authority to save their own information bubbles by selecting and saving portions of the filtered information.

According to another embodiment, electronic information selected from the filtered electronic information and saved in the information bubble is removed from the filtered electronic information to avoid duplication of electronic information in the notebook.

According to a further embodiment, the filter parameters are received from one or more users in a collaborative environment, each user having the authority to set their own filter parameters and create their own information bubbles.

According to yet another embodiment, the method further comprises providing a dashboard, the dashboard including a notification of of user activities in the notebook e.g. add/remove collaborators; add/remvoe notebooks; add/remove assignments.

According to another embodiment, there is provided a system for managing electronic information, the system comprising: an input adapted to receive, from a remote user device over a communication network, a first user input comprising a search topic; a processor having access to statements and instructions which when executed cause the processor to collect electronic information about the search topic from at least one remote information source over the communication network; a memory for packaging the collected electronic information in discrete information containers; and an output for sending the discrete information containers to the remote user device for display.

According to a further embodiment, the system receives a set of filter parameters, and filters the collected electronic information using the set of filter parameters prior to packaging it.

According to yet another embodiment, the system is adapted to create an empty notebook, abbreviate the filtered electronic information of each information container in an information bubble, and organize the filtered electronic information in the notebook as a list of information bubbles.

According to another embodiment, the system displays the full content of the information container upon detecting a pointing device clicking or moving over the information bubble.

According to a further embodiment, the filter parameters are received from one or more users in a collaborative environment, the users having access to a single pool of filtered electronic information, and having the authority to create their own information bubble by selecting and saving portions of the filtered electronic information.

According to yet another embodiment, the filter parameters are received from one or more users in a collaborative environment, each user having the authority to set their own filter parameters and create their own information bubbles.

In another aspect, there is provided a method for managing electronic information, the method comprising: receiving, from a remote user device over a communication network, a first user input comprising a search topic and a set of filter parameters; collecting electronic information about the search topic from at least one remote electronic information source over the communication network; filtering the collected information based on the set of filter parameters to produce filtered electronic information; abbreviating the filtered electronic information and packaging the abbreviated information in information bubbles; creating an electronic notebook and listing the information bubbles in the electronic notebook; and sending the electronic notebook to the remote user device for display.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a flowchart of a method for information gathering in accordance with an embodiment;

FIG. 2 is a flow chart of the process for creating and filling the electronic notebook with information containers in accordance with another embodiment;

FIG. 3a is a diagram of a general structure of a notebook in accordance with another embodiment;

FIG. 3b is a diagram of a structure of a notebook, where at least three operations can be done on the information bubbles within the content stream in accordance with another embodiment;

FIG. 4 is a diagram illustrating the general structure of an exemplary collaborative notebook in accordance with another embodiment;

FIG. 5 is a diagram illustrating the general structure of an exemplary collaborative notebook in accordance with another embodiment;

FIG. 6 is a flowchart of a process for creating and publishing content in accordance with another embodiment;

FIG. 7 is a flowchart of a method for creating and adding content to the system in accordance with another embodiment;

FIG. 8 is an example of a discreet and localized comment in a text in accordance with another embodiment;

FIG. 9 is a flowchart of a method for managing electronic information in accordance with another embodiment;

FIG. 10 illustrates a computing environment in accordance with another embodiment;

FIG. 11 illustrates an embodiment of a computing device, where the client machine and server illustrated in FIG. 10 can be deployed as and/or executed on any embodiment of the computing device;

FIG. 12a is an example of a dashboard in accordance with another embodiment;

FIG. 12b is an example of a dashboard in accordance with another embodiment;

FIG. 12c is an example of a dashboard in accordance with another embodiment; and

FIGS. 13 and 14 illustrate how the user may select a sentence and provide a comment thereon in accordance with another embodiment.

It will be noted that throughout the appended drawings, like features are identified by like reference numerals.

### DETAILED DESCRIPTION

The present embodiments describe a system and method for managing electronic information. The system may receive a search topic from a remote user over a communication network and optionally a set of filter parameters e.g search keywords, information sources, time etc. The system may then collect information about the search topic from at least one remote information source over the communication network. The collected information is then filtered in accordance with the filter parameters and packaged in discrete information containers. The discrete information containers may then be sent to the remote user device for display.

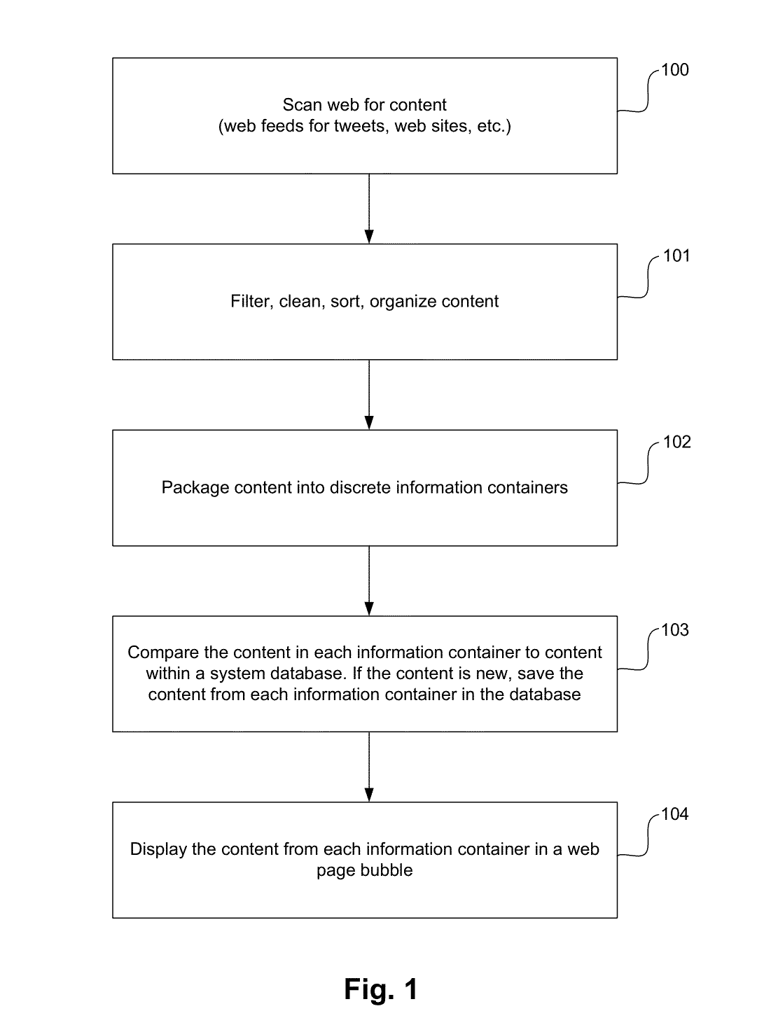

FIG. 1 is a flowchart of a method for information gathering in accordance with an embodiment. The method begins at step 100 by gathering information related to a topic from the web by querying web sites for their web feed information. This information can come from many different sources such as, but not limited to, news sites, magazine sites, blogs, vlogs, Twitter, Facebook and the like. Any web site that provides a feed can be a source. Most feeds on the internet use either the RSS or ATOM format, which are standard web syndication formats, however, the methodology herein can work with any feed format. The content of the information can be in the form of text, images, sound, video or any combination thereof.

Step 101 includes filtering, processing and organizing the gathered information. Step 102 includes cleaning, reformatting and categorizing or sorting the gathered information and organizing it into discrete information containers (aka information bubbles). After organizing into discrete information containers the data representing the information is compared (103) to saved data in a database, referred to herein as the system database. The database holds at least two groups of data: one is specific saved data related to a given search (or several linked searches) and another is all the data from all searches. The saved data represents stored information containers that were saved previously. The comparison is an attempt to eliminate duplication of the content within information containers both within the database and also for a user's display. In an embodiment, the database may include two parts: a general part where all the data from all the searches ever done are stored, and a specific part that includes saved data selected for each notebook. Data may be new to a specific notebook even if it is not new to the general database. If the content with the gathered information containers match the contents of a saved information container, then the gathered information container is not saved again in either of the two groups of data in the database. Otherwise it is saved in the database. Subsequent gathering of information searches both the web and the system database. If the gathered information containers have new content with respect to a given search (or several linked searches), the content within the information containers is also displayed on an electronic display (104). The displayed information containers are referred to as information bubbles throughout the description herein. The information bubbles show an abridged version of the total information content such as at least one of the following: a title or partial title, a picture or partial picture, a body of text or a partial section of the body of text. Clicking on the information bubble with a mouse will allow access to the full content of the bubble displayed by either expanding the bubble or by displaying the content in a new web page.

### Electronic Notebooks:

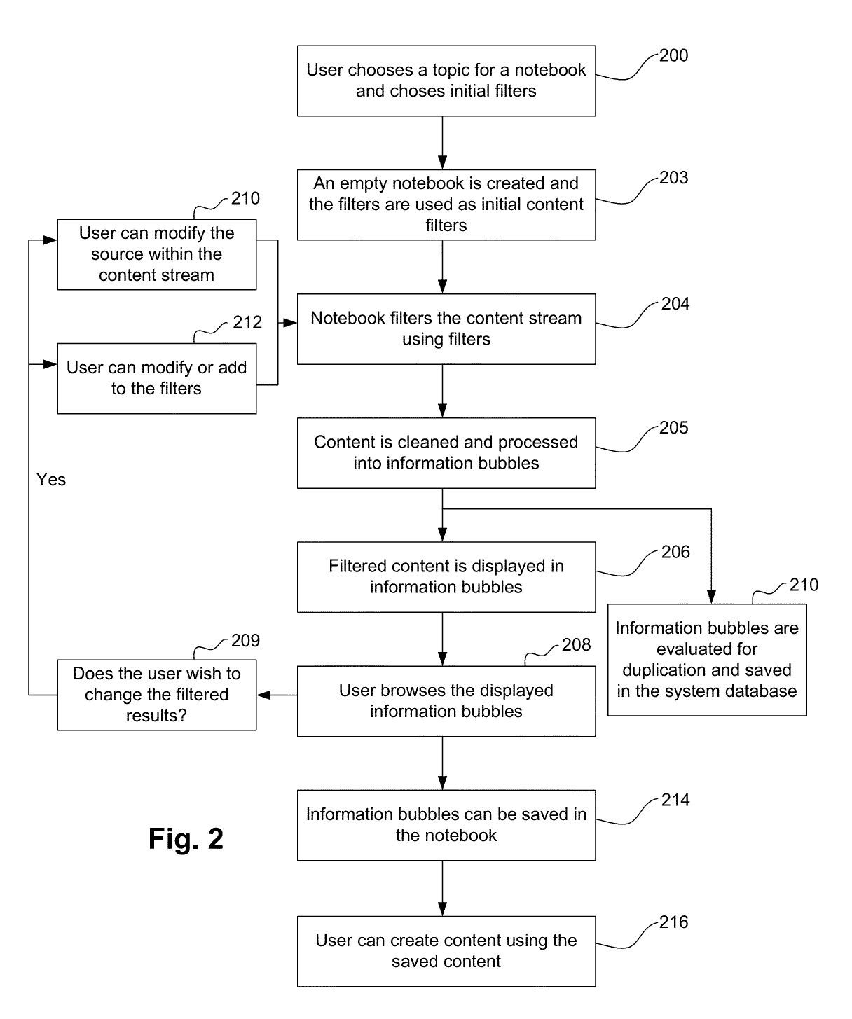

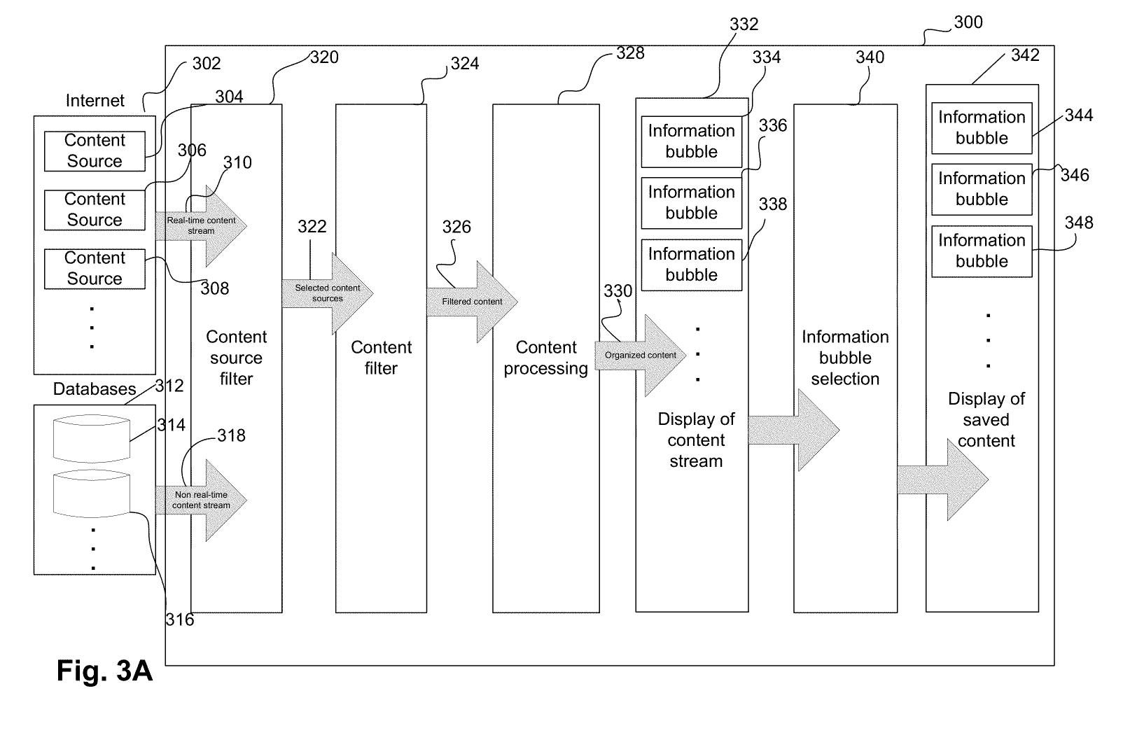

In another embodiment, there is provided an electronic notebook representing a curation tool and repository for information bubbles related to a certain topic. FIG. 2 is a flow chart of the process for creating and filling the electronic notebook with information containers in accordance with an embodiment, and FIG. 3a is a diagram of a general structure of a notebook in accordance with an embodiment. The electronic notebook allows for information bubbles to be discovered and saved in an organized way.

As exemplified in FIG. 3, the electronic notebook 300 comprises at least three main components: a content filter 324, a stream of filtered content 332 in the form of information bubbles 334, and a repository 342 for saved content in the form of information bubbles. The content filter (324) uses filtering parameters to filter the content within content sources from the web (302) or from databases (312). Optionally, there may also be a source filter (320) before the content filter 324 to filter out entire groups of sources. Filtering parameters can include many different types such as, but not limited to, keywords, location, time, social engagement, language and relevance. In an embodiment, the filtering parameters are typically chosen by a user but they could also be chosen by an algorithm.

In an embodiment, the content (326) that passes through the content filter 324 is processed and organized using a content processing module 328 to exit the latter in the form of organized content 330. The organized content 330 may then be joined into the notebook stream (332). In the present embodiment, the notebook stream 332 is a real-time updated stream of content related to a given topic and defined by the filter parameters and displayed as a series of information bubbles. The notebook stream 332 may be updated on an ongoing basis which is dependent on the output rate of content from the sources and the restrictiveness of the filters. Information bubbles in the notebook stream 332 can be permanently saved in the notebook by selecting them (340) and placing them in the saved content (342). The choice of which information bubbles to be saved in the notebook may either be made by the user or by an algorithm.

Referring back to FIG. 2, there is illustrated a flowchart of a method for creating and filling the electronic notebook with information containers in accordance with an embodiment. The method begins at step 200 where a user decides to create a notebook based around a topic and chooses a set of filters that can be used to filter the content to find content related to the selected topic. At step 203, an empty notebook is created and the determined filters are used as an initial set of filters. At step 204 the notebook uses the filter parameters to filter streams of content coming from the internet or from a database. At step 205 the content that passes through the filter is cleaned and processed. At step 206 the content that passes through the filter is displayed for the user in information bubbles If it has not been displayed previously during previous searches. At step 210 the information bubbles are sent to the system database for storage. In an embodiment, before being stored the content may be evaluated for duplication with respect to the content already in the system database. If the information bubbles are determined to be new content they are added to the system database (210). The filtered information bubbles can be presented to the user as a stream of bubbles in a column and where new bubbles come in from the top and the older bubbles are pushed down. At step 208 the user may browse the displayed information bubbles, and at step 209 the user may decide if they want to change the filters and thus change the streamed content. At step 212 the user can change the presented content stream by modifying the filters and generating new filtered content. Alternatively, to change the presented content the user can modify the sources at step 210 within the content stream to generate new filtered content. At step 214 the user can choose to save the information bubbles in the notebook. At step 216 the saved content can be used to create new content using the saved content.

In one embodiment, the visual display of a notebook is split into a plurality of sections with at least one section displaying saved content and at least one other section displaying the content stream. Optionally, it is also possible to display the content filters section which indicates the filters used to filter the content. An example of a visual display of a notebook is illustrated in

FIG. 3b. As shown in the example of FIG. 3b, at least three operations can be done on the information bubbles within the content stream:
1. The information bubbles can be deleted and ignored by the notebook;
2. The information bubbles can be saved in a database used by a notebook and used to generate more search parameters while not being displayed in the notebook; and
3. The information bubbles can be saved in the database and displayed in the notebook and used to generate more search term parameters.

When embodied in a system, the electronic notebooks can be privately held by a single user, a group of users, or it can be made public and available to all users. In an embodiment the electronic notebooks can be used in a collaborative environment where the collaboration may be performed in real time. In this aspect, the saved content of a notebook may be accessible to all users in a collaborative group.

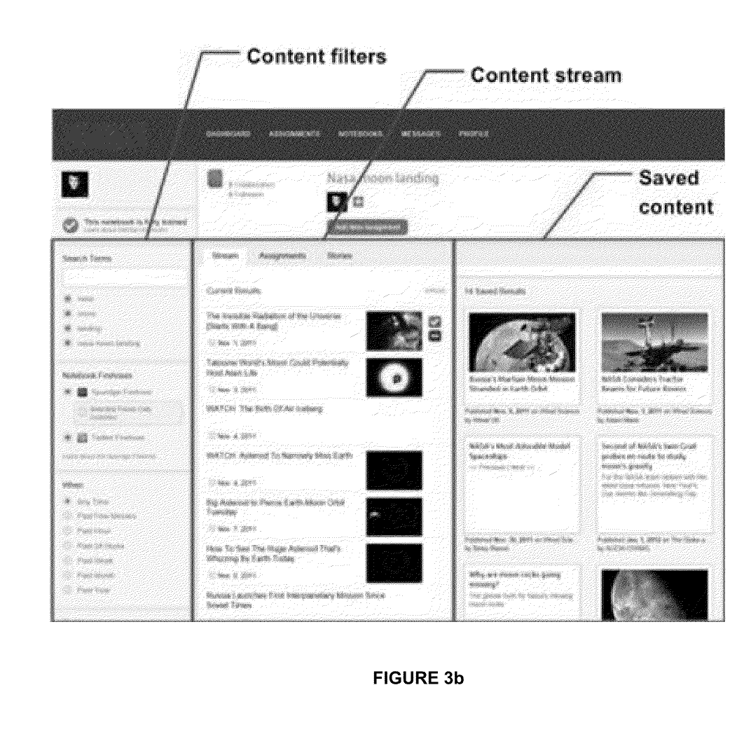

FIG. 4 is a diagram illustrating the general structure of an exemplary collaborative notebook, in accordance with an embodiment. In the example of FIG. 4 all the members of the collaborative group that share the collaborative notebook (400) share many of the notebook's attributes. In this embodiment, the group shares the same search parameters therefore leading to a common content filter (404), which also leads to a common content stream (406). This may be implemented in a variety of ways. For example, it could be that when one person makes a change in the filters the change is set for everyone whereby every user may have access to the same content stream. Even though the content stream is common the stream can be displayed on independent display devices. In an embodiment, the saved content (420) within the notebook is also common to all members of the collaborative group. However each member of the group can independently choose (414, 416,418) information containers to place in the saved content. When any member of the group adds an information container to the saved content, all members of the group see an updated saved content field (420). In an embodiment, the information selected by the one user disappears from the stream, thus avoiding duplication of information in the notebook.

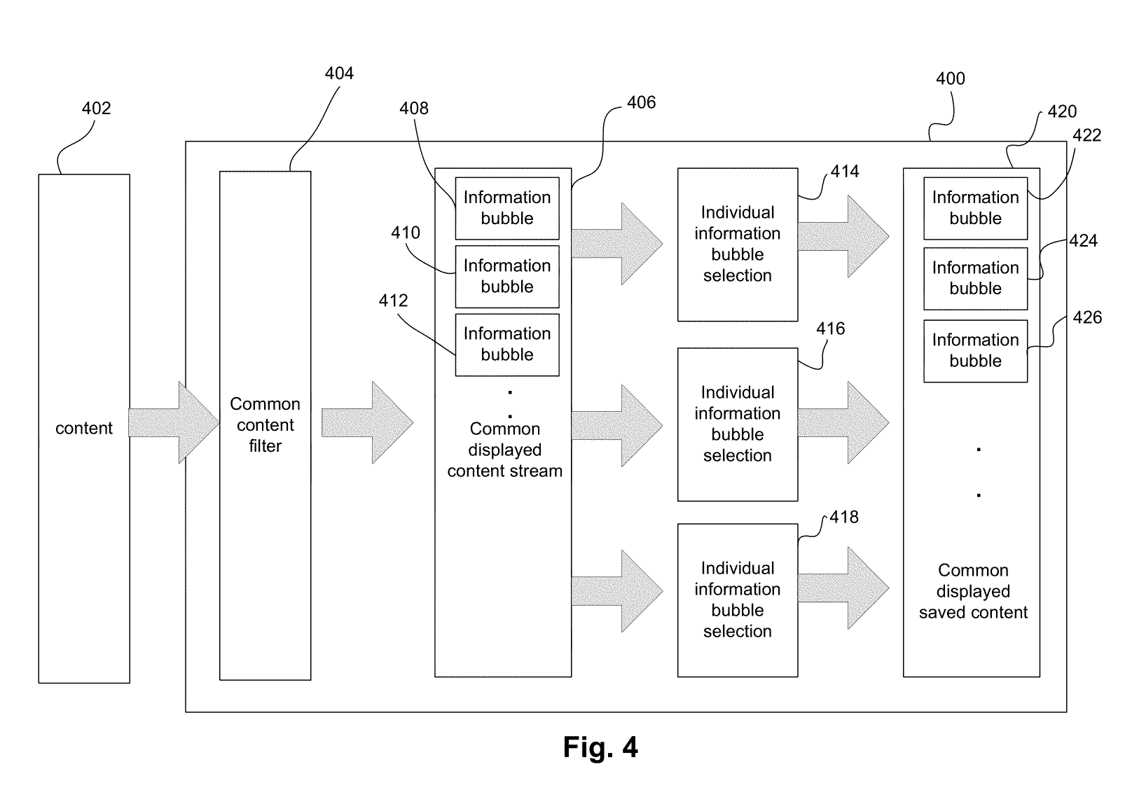

FIG. 5 is a diagram illustrating the general structure of an exemplary collaborative notebook, in accordance with another embodiment. By contrast to the embodiment of FIG. 4, in the example of FIG. 5 only the saved content display (522) is shared amongst the members of the collaborative group. In this embodiment, each user has an independent filter (504, 506, 508) with their own chosen filter parameters. This independent filtering leads to independent content streams (510, 512, 514) generated by each unique set of filter parameters. Each user can then independently choose (516, 518, 520) the information bubbles that go into the common saved content. Once any one member of the group adds an information container to the saved content, all members of the group see an updated saved content field (522).

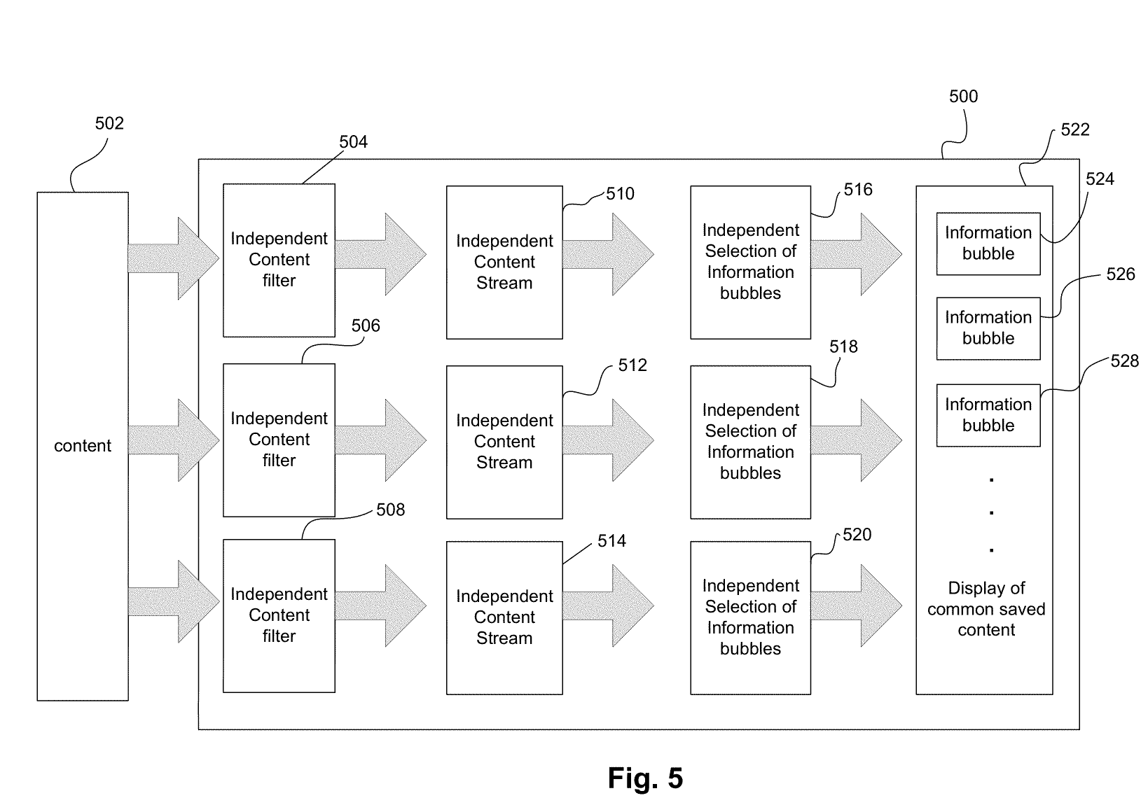

In a further embodiment, an individual may automatically extract the information on a web site and create a single information bubble with that information. This may be embodied as a plug-in for a web browser. FIG. 6 is a flowchart of a process for creating and publishing content in accordance with an embodiment. The method begins at step 600 where a user browses the web and finds a web page with content that they wished to convert into an information bubble. At step 602 the plug-in provides a button for the user to click to convert the content on the web page to an information bubble. At step 604 the plug-in executes an algorithm to analyze all the content on the web page as well as the formatting and structure of the page. In an embodiment, the analysis determines what sections of the web page constitute the content for the information bubble. At step 606, the extracted information is cleaned and organized and placed into an information bubble. The user may then decide which of the notebooks the information bubble is placed into.

### Content Creation

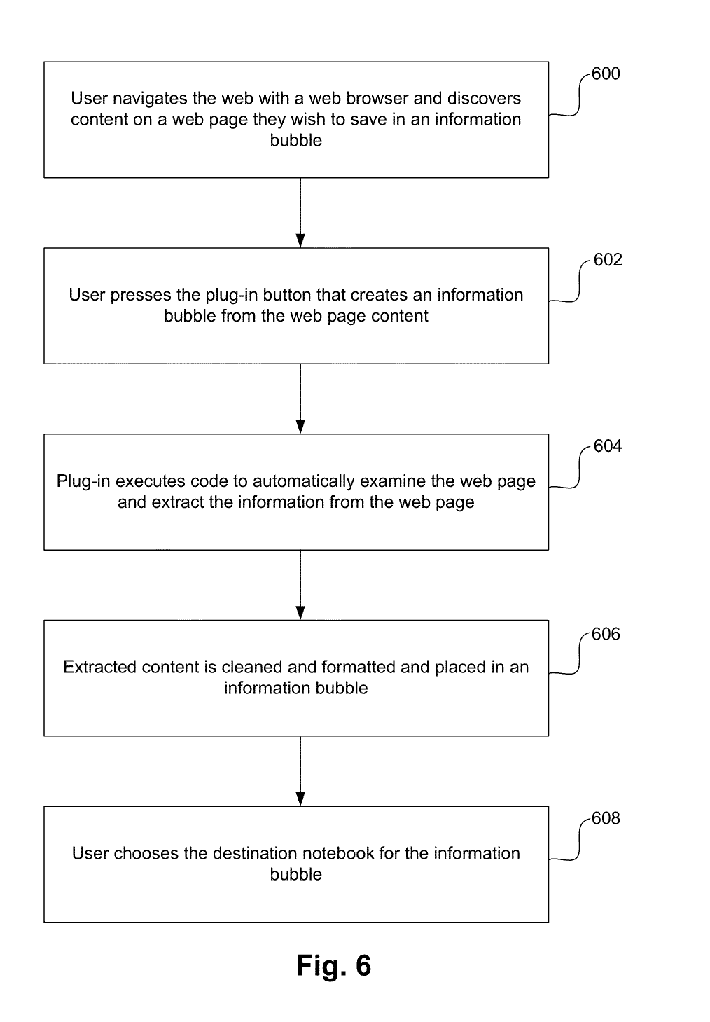

FIG. 7 is a flowchart of a method for creating and adding content to the system in accordance with an embodiment. As shown in FIG. 7, content can be created and added to the system database or broadcast on the web or syndicated on targeted 3rd party systems. A content creation editor allows a user to create content while simultaneously viewing information bubbles or notebooks. The display for the editor is split into a plurality of sections with at least one section displaying the editor and at least one other section displaying saved content or the live stream of content. The said saved content can be one notebook, or a group of notebooks or single bubble, or a group of bubbles or similar grouping of saved content. The editor allows a user to enter and format text (704). Content can be taken from a bubble in the saved content and be drag-and-dropped, or copy-pasted (706) into the new content within the content creation editor.

In another aspect, a link is automatically provided (708) between the newly created content and the source of the content (the information bubble in the saved content or a link to the information bubble in the system database). The link being a footnoted reference to the original bubble and its content. The reference includes a standard article reference with information such as author, publishing date, publisher and the like. The reference also contains a hypertext link that will find and display the original information bubble and its content retrieved from the system database.

Content can be created in a collaborative way between multiple users. In an embodiment, there may be different collaborative relationships where the different users involved in the collaboration may have different levels of control and accessibility. For example, some users may have a greater level of control similar to an editor from a newsroom. A user who is creating content may begin a collaboration effort by requesting the collaboration of a plurality of other users. This request can be in the form of a message, or email or in a notification to the requested user. If any of these requested users accepts the invitation to collaborate, then they are given access to a shared version of the content so that they may contribute. A plurality of users can work in collaboration on the same content at the same time.

When content is created, it may be uploaded to the system database as new information bubble so that other users can view, save and comment on the information bubble (716). Content can also be syndicated to other content creation platforms or publishing platforms. The content creation process can then continue in these other independent platforms. The syndication can have a single target destination or multiple target destinations.

Content can also be created within the framework of an assignment system. The assignment system is a system whereby content creation is tracked. An assignment is a request for content creation given to a user as a task or duty. An assignment can be created and given to oneself, or to another user, or an assignment can be given by an automated agent. Assignments can also be ‘pitched’ to another user. A pitched assignment is an idea for an assignment that is sent to another user. The user that receives the pitched assignment then has the option to accept the idea for an assignment and create the assignment and give that assignment to any user they choose. The progress or status of an assignment is tracked and each user involved in the assignment can receive status updates, as an email or other message notification if they choose to.

The system also has the ability to upload the new user created content to professionals or professional organizations such as for example to professional writers or journalists. In this case the content is not yet available to the general user, or it might be available to the general user but flagged as content under verification. The professionals then have the ability to validate the user generated content in the information bubble. The information bubble will then appear in the system as a validated information bubble, with the validating agent noted or given credit. Alternatively, the information bubble may be removed from the system by the validator.

### Discreet and Localized Commenting:

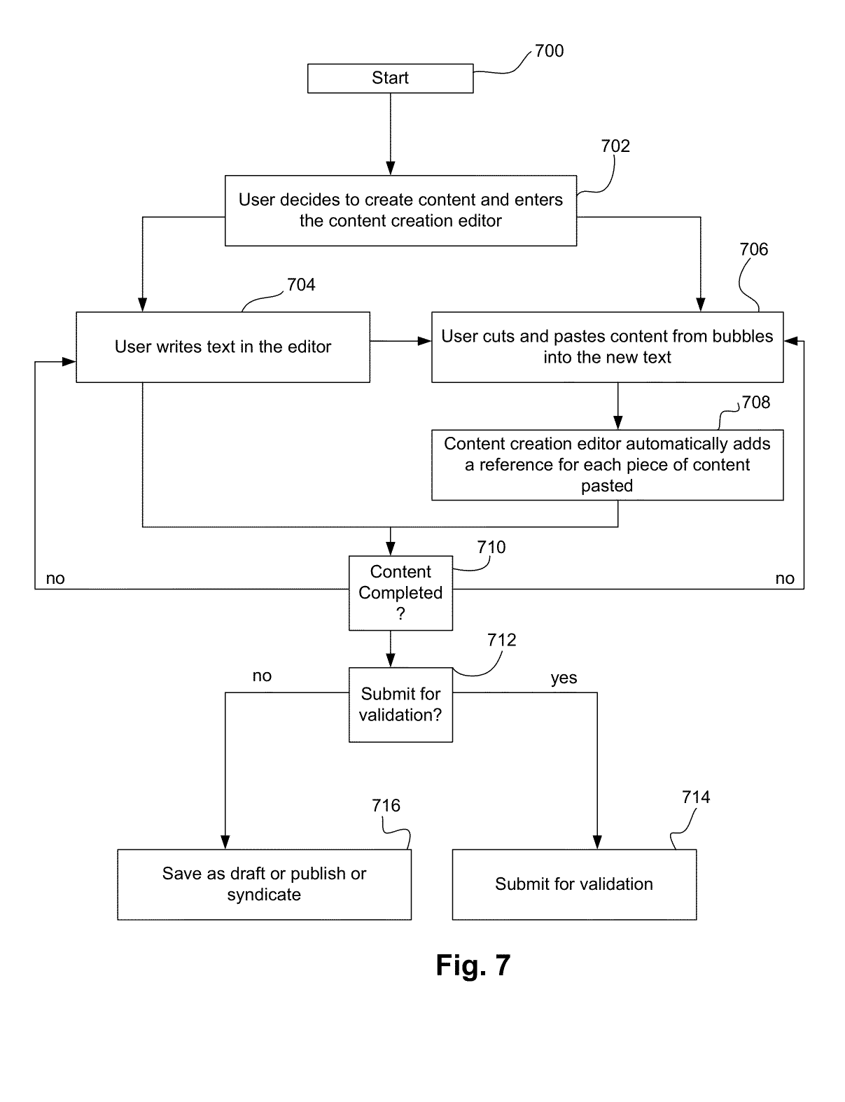

FIG. 8 is an example of a discreet and localized comment in a text in accordance with an embodiment. As shown in FIG. 8, when an information bubble contains a body of text, a user can add localized comments within the body of the text by selecting a section of text. Upon selection, a small callout box or window appears and the user can type text into the callout box or window. Once entered, the comments become embedded in the information bubble on the system database. Other users can see and respond to comments when they open the said information bubble containing the comment. The said comments are localized, meaning they are linked to a location in the text such as a word or a sentence. When the callout box is closed, the comment becomes hidden and only a small symbol is left in the text to denote the location of the comment. The full body of the comment can be seen if the mouse is passed over the symbol or if the symbol is clicked or otherwise selected. This allows for comments to be discreetly added to the body of the text without being visually disruptive to a reader.

In a further aspect, beyond just denoting the location of a comment, the symbol represents a placeholder for complex commenting and conversations. By double clicking, or by some other means selecting the symbol for expansion, the symbol expands into a window showing the original highlighted comment and any other responses specific to that comment. Each one of these symbols is a connection to a debate, or conversation tied specifically to that highlighted text and not to the story as a whole. These conversations appear in a separate window outside of the main body of text. This allows for concentrating the debates and discussions over specific subjects and/or statements in the notebook. This may also avoid the discussion chaos that happens in conventional websites where thousands of readers comment on different statements and disagree with each other not knowing what each person is commenting about.

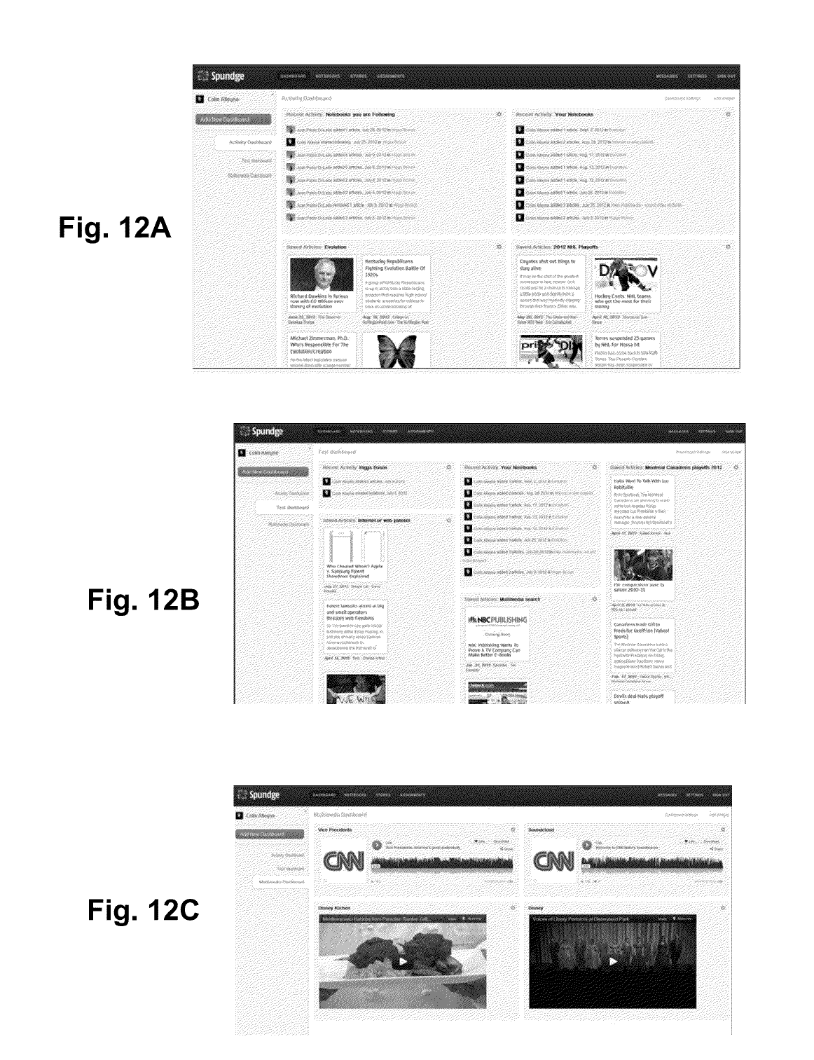

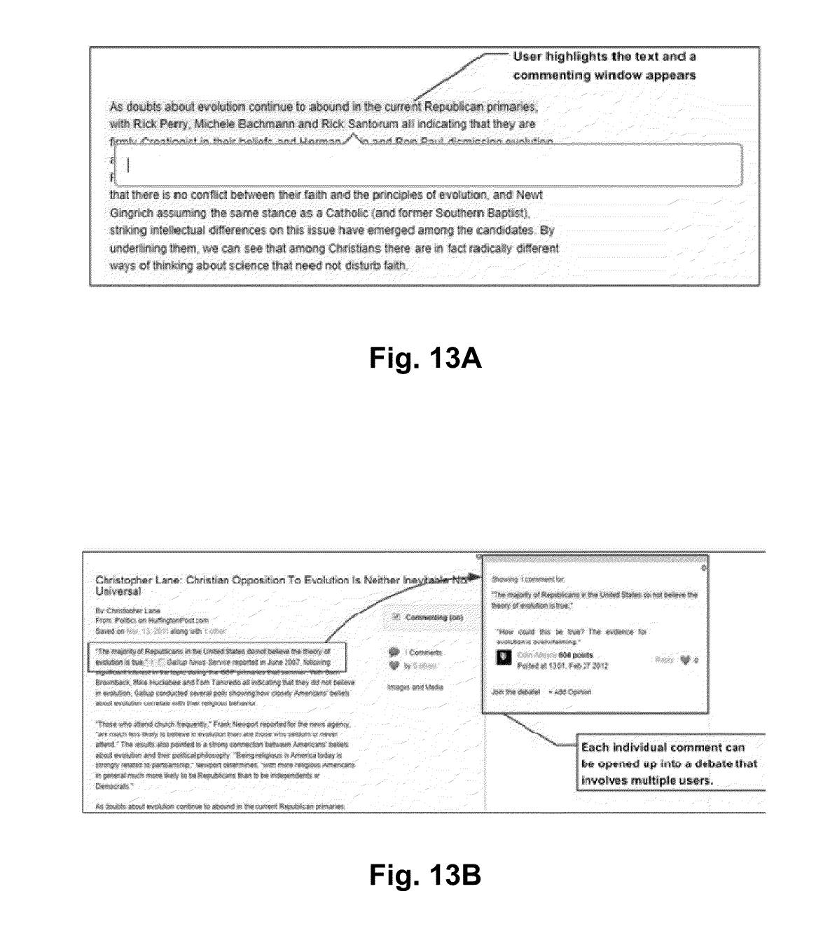

An example is shown in FIGS. 13 and 14 which illustrate how the user may select a sentence and provide a comment thereon. When the text is selected a comment bubble may appear where the user can enter their comment about a specific sentence or statement. Other user may also provide their comment in the bubble without disrupting the view.

### User Credibility Ranking System:

A ranking system is used to rank the credibility of users. The rank is determined by many aspects of the user's activity such as the amount of involvement in the site, popularity of their submitted information bubbles, number of professional validations for submitted information bubbles, the number of complaints against their submitted information bubbles, and the like. A user's credibility can be linked to the submission of their bubbles for professional review. Users with a high credibility could have their submissions ranked higher and might have their stories reviewed faster. Similarly, information bubbles linked to users with high credibility could appear more prominently when a search is performed in the system.

### Call for Input:

Entities such as professional associations, organizations, or individuals such as journalists, or the like can use the system to send out a call to all users, or a call to a particular subset of users, to gather information on a given topic and upload the information into information bubbles which would be accessible only to the user(s) that created the call. The call for input can be both time and location sensitive meaning that the call might go out only for a specific time period and in a specific geographical location. The said call for input is a tool that can be used to verify current trending topics or a recent event. For example, consider an event such as a local story breaking regarding a famous movie star being seen walking around a small town with a new love interest. A geographically localized call for input could be broadcast to users near that location requesting them to verify the story with eyewitness accounts or cell phone images uploaded to information bubbles. The location of a user could be determined via their profile page or GPS readout from their cell phone or by some other means.

User may have followers of a one or more of their notebooks. When prescribing as follower, each follower may have access to the saved content of specific notebooks that they are following without being able to edit or modify the saved content of the followed notebook.

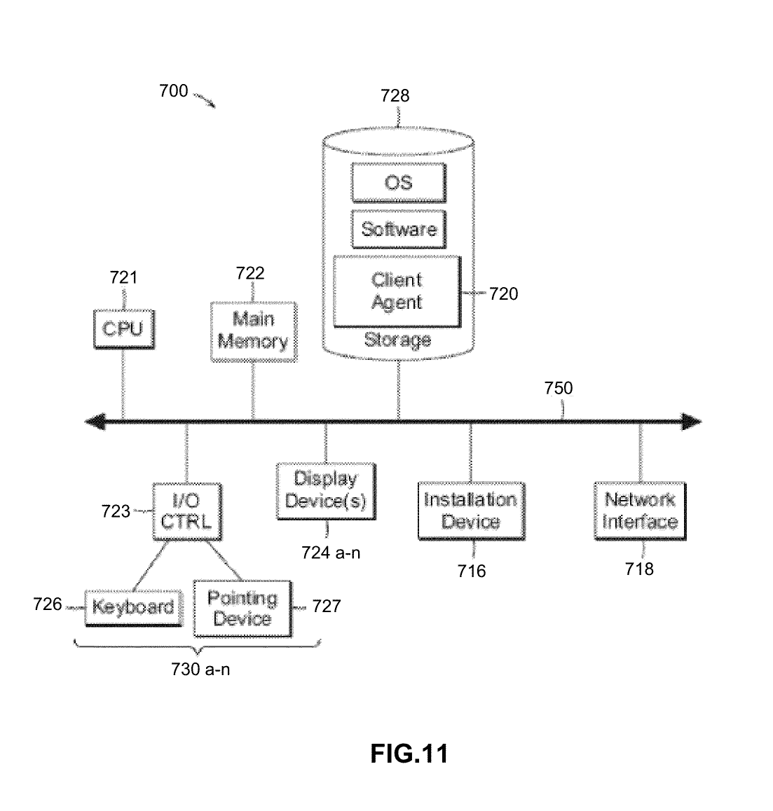

In an embodiment the notebook may include a dashboard. The dashboard includes notification of each entry of saved content and optionally a timestamp of the entry, a picture, text or a portion of the content. The dashboard can also include notifications of the addition or subtraction of followers to a notebook, and the creation or deletion of notebooks, and the addition or subtraction of assignments. The dashboard can also show activity in notebooks that a user is following or notebooks that a user is collaborating on. The dashboard may also be shared and made available for viewing by the other users. In an embodiment, entries in the dashboard may be provided in the form of widgets (windows or the like) that may be moved around on the screen within the dashboard. The entries may be updated in real time as more entries are added into the notebook. Examples of dashboards are included in FIGS. 12a to 12c.

In a further embodiment, the user may embed the content stream section or saved content section (or both) of a notebook in a website by using an embed code or by dragging the selected section and dropping it in the website. For example, the user may select a section of the notebook and embed it a Facebook page, or any website they choose. Whereby, when changes occur in the notebook, the changes may be reflected automatically in the website in which the content stream section or saved content section were embedded without user intervention.

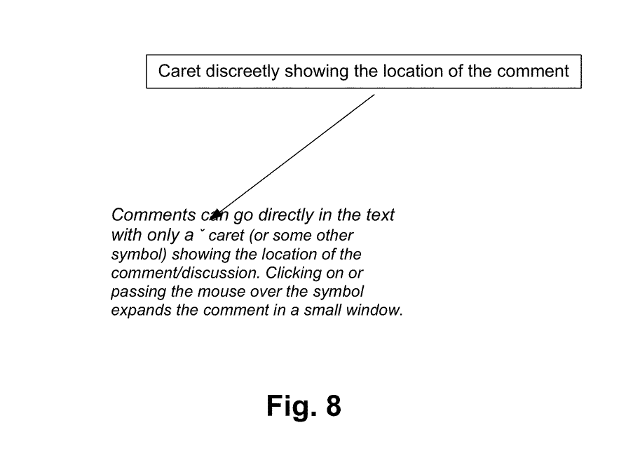

FIG. 9 is a flowchart of a method of for managing electronic information in accordance with an embodiment. The method 270 begins at step 272 by receiving, from a remote user device over a communication network, a first user input comprising a search topic. Step 274 includes collecting information about the search topic from at least one remote information source over the communication network. Step 276 includes packaging the collected information in discrete information containers. Step 278 includes sending the discrete information containers to the remote user device for display.

### Hardware and Operating Environment

The embodiments may be implemented in a server accessed by users over a communication network using a website associated with the server. In an embodiment, an API (Application Program Interface) may be installed on different websites which are not associated with the server for transferring the search topic to the server and obtain search results to be presented on these different websites from the server. Details of an exemplary computing environment in which the embodiments may be practiced are provided below.

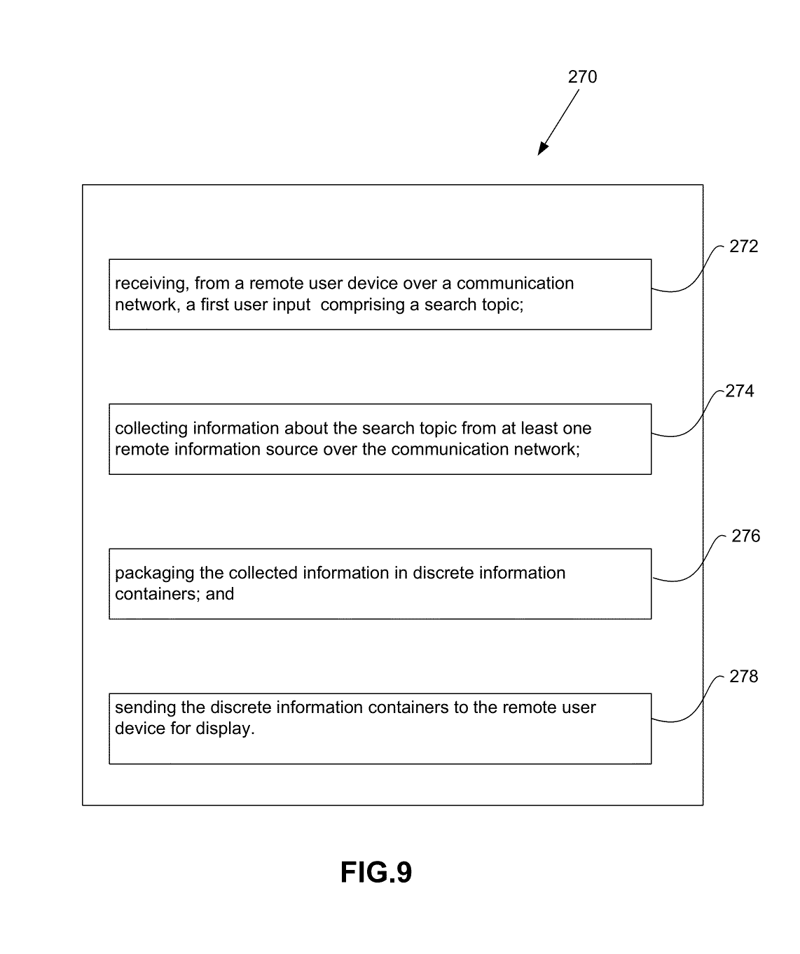

FIG. 10 illustrates one embodiment of a computing environment 701 that includes one or more client machines 702A-702N in communication with servers 706A-706N, and a network 704 installed in between the client machines 702A-702N and the servers 706A-706N. In some embodiments, client machines 702A-70N may be referred to as a single client machine 702 or a single group of client machines 702, while servers may be referred to as a single server 706 or a single group of servers 706. One embodiment includes a single client machine 702 communicating with more than one server 706, another embodiment includes a single server 706 communicating with more than one client machine 702, while another embodiment includes a single client machine 702 communicating with a single server 706.

A client machine 702 within the computing environment may in some embodiments, be referenced by any one of the following terms: client machine(s) 702; client computer(s); end-user's computer. It is also to be noted that a client machine may also function as a server and vice versa.

The client machine 702 can in some embodiments execute, operate or otherwise provide an application that can be any one of the following: software; a program; executable instructions; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other type and/or form of executable instructions capable of executing on client machine 702. Still other embodiments may include a computing environment 701 with an application that is any of either server-based or remote-based, and an application that is executed on the server 706 on behalf of the client machine 702. Further embodiments of the computing environment 701 include a server 706 configured to display output graphical data to a client machine 702 using a thin-client or remote-display protocol, where the protocol used can be any one of the following protocols: the Independent Computing Architecture (ICA) protocol manufactured by Citrix Systems, Inc. of Ft. Lauderdale, Fla.; or the Remote Desktop Protocol (RDP) manufactured by the Microsoft Corporation of Redmond, Wash.

In one embodiment, the client machine 702 can be a virtual machine 702C such as those manufactured by XenSolutions, Citrix Systems, IBM, VMware, or any other virtual machine able to implement the methods and systems described herein.

The computing environment 701 can, in some embodiments, include more than one server 706A-706N where the servers 706A-706N are: grouped together as a single server 706 entity, logically-grouped together in a server farm 706; geographically dispersed and logically grouped together in a server farm 706, located proximate to each other and logically grouped together in a server farm 706. Geographically dispersed servers 706A-706N within a server farm 706 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 706 may be administered as a single entity or in other embodiments may include multiple server farms 706. The computing environment 701 can include more than one server 706A-706N grouped together in a single server farm 706 where the server farm 706 is heterogeneous such that one server 706A-706N is configured to operate according to a first type of operating system platform (e.g., WINDOWS NT, manufactured by Microsoft Corp. of Redmond, Wash.), while one or more other servers 706A-706N are configured to operate according to a second type of operating system platform (e.g., Unix or Linux); more than one server 706A-706N is configured to operate according to a first type of operating system platform (e.g., WINDOWS NT), while another server 706A-706N is configured to operate according to a second type of operating system platform (e.g., Unix or Linux); or more than one server 706A-706N is configured to operate according to a first type of operating system platform (e.g., WINDOWS NT) while more than one of the other servers 706A-706N are configured to operate according to a second type of operating system platform (e.g., Unix or Linux).

The computing environment 701 can in some embodiments include a server 706 or more than one server 706 configured to provide the functionality of any one of the following server types: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 706 configured to operate as an active direction; a server 706 configured to operate as application acceleration application that provides firewall functionality, application functionality, or load balancing functionality, or other type of computing machine configured to operate as a server 706. In some embodiments, a server 706 may include a remote authentication dial-in user service such that the server 706 is a RADIUS server. Embodiments of the computing environment 701 where the server 706 comprises an appliance, the server 706 can be an appliance manufactured by any one of the following manufacturers: the Citrix Application Networking Group; Silver Peak Systems, Inc; Riverbed Technology, Inc.; F5 Networks, Inc.; or Juniper Networks, Inc. Some embodiments include a server 706 with the following functionality: a first server 706A that receives requests from a client machine 702, forwards the request to a second server 706B, and responds to the request generated by the client machine with a response from the second server 706B; acquires an enumeration of applications available to the client machines 702 and address information associated with a server 706 hosting an application identified by the enumeration of applications; presents responses to client requests using a web interface; communicates directly with the client 702 to provide the client 702 with access to an identified application; receives output data, such as display data, generated by an execution of an identified application on the server 706.

The server 706 can be configured to execute any one of the following applications: an application providing a thin-client computing or a remote display presentation application; any portion of the CITRIX ACCESS SUITE by Citrix Systems, Inc. like the METAFRAME or CITRIX PRESENTATION SERVER; MICROSOFT WINDOWS Terminal Services manufactured by the Microsoft Corporation; or an ICA client, developed by Citrix Systems, Inc. Another embodiment includes a server 706 configured to execute an application so that the server may function as an application server such as any one of the following application server types: an email server that provides email services such as MICROSOFT EXCHANGE manufactured by the Microsoft Corporation; a web or Internet server; a desktop sharing server; or a collaboration server. Still other embodiments include a server 706 that executes an application that is any one of the following types of hosted servers applications: GOTOMEETING provided by Citrix Online Division, Inc.; WEBEX provided by WebEx, Inc. of Santa Clara, Calif.; or Microsoft Office LIVE MEETING provided by Microsoft Corporation.

In one embodiment, the server 706 may be a virtual machine 706B such as those manufactured by Citrix Systems, IBM, VMware, or any other virtual machine able to implement the methods and systems described herein.

Communication between the client machine 702 and either a server 706 or servers 706A-706N can be established via any of the following methods: direct communication between a client machine 702 and a server 706A-706N in a server farm 706; a client machine 702 that uses a program neighborhood application to communicate with a server 706a-706n in a server farm 706; or a client machine 702 that uses a network 704 to communicate with a server 706A-706N in a server farm 706. One embodiment of the computing environment 701 includes a client machine 702 that uses a network 704 to request that applications hosted by a server 706A-706N in a server farm 706 execute, and uses the network 704 to receive from the server 706A-706N graphical display output representative of the application execution.

The network 704 between the client machine 702 and the server 706 is a connection over which data is transferred between the client machine 702 and the server 706. Although the illustration in FIG. 10 depicts a network 704 connecting the client machines 702 to the servers 706, other embodiments include a computing environment 701 with client machines 702 installed on the same network as the servers 706. Other embodiments can include a computing environment 701 with a network 704 that can be any of the following: a local-area network (LAN); a metropolitan area network (MAN); a wide area network (WAN); a primary network 704 comprised of multiple sub-networks 704′ located between the client machines 702 and the servers 706; a primary public network 704 with a private sub-network 704′; a primary private network 704 with a public sub-network 704′; or a primary private network 704 with a private sub-network 704′. Still further embodiments include a network 704 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; a network 704 that includes a wireless link where the wireless link can be an infrared channel or satellite band; or any other network type able to transfer data from client machines 702 to servers 706 and vice versa to accomplish the methods and systems described herein. Network topology may differ within different embodiments, possible network topologies include: a bus network topology; a star network topology; a ring network topology; a repeater-based network topology; a tiered-star network topology; or any other network topology able transfer data from client machines 702 to servers 706, and vice versa, to accomplish the methods and systems described herein. Additional embodiments may include a network 704 of mobile telephone networks that use a protocol to communicate among mobile devices, where the protocol can be any one of the following: AMPS; TDMA; CDMA; GSM; GPRS UMTS; or any other protocol able to transmit data among mobile devices to accomplish the systems and methods described herein.

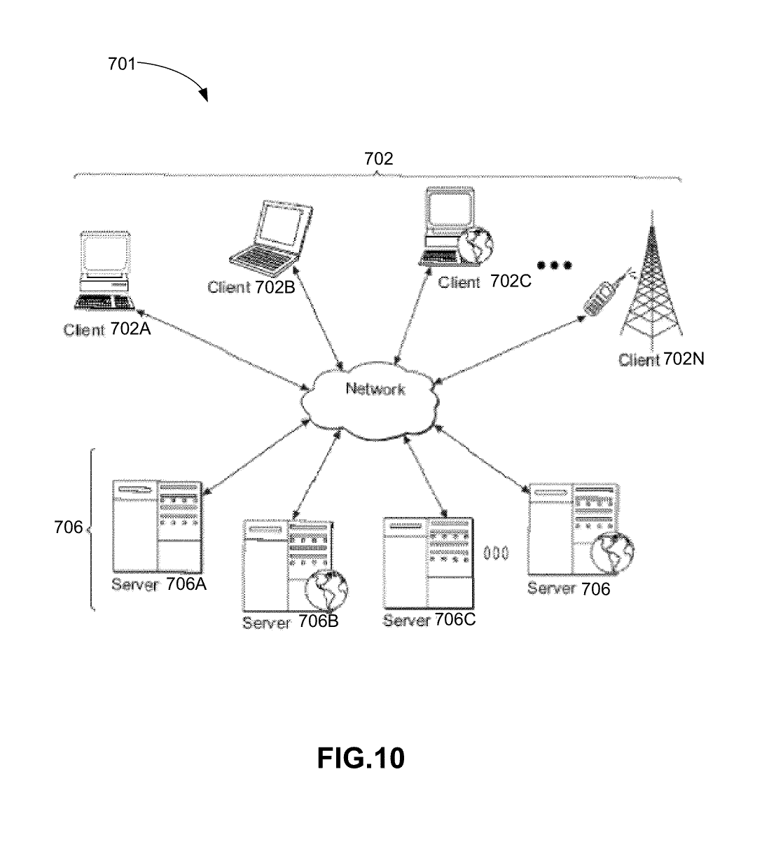

FIG. 11 illustrates an embodiment of a computing device 700, where the client machine 702 and server 706 illustrated in FIG. 10 can be deployed as and/or executed on any embodiment of the computing device 700 illustrated and described herein. The computing device 700 comprises a system bus 750 that communicates with the following components: a central processing unit 721; a main memory 722; storage memory 728; an input/output (I/O) controller 723; display devices 724A-724N; an installation device 716; and a network interface 718. In one embodiment, the storage memory 728 includes: an operating system, software routines, and a client agent 720. The I/O controller 723, in some embodiments, is further connected to a key board 726, and a pointing device 727. Other embodiments may include an I/O controller 723 connected to more than one input/output device 730A-730N.

Those skilled in the art will appreciate that the invention may be practiced with other browser/web-enabled computer system configurations, including hand-held devices, multiprocessor systems, microprocessor-based or programmable consumer electronics, network PCS, minicomputers, mainframe computers, and the like. The invention may also be practiced in distributed computing environments where tasks are performed by remote processing devices that are linked through a communications network. In a distributed computing environment, program modules may be located in both local and remote memory storage devices.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method for managing electronic information, the method comprising:
receiving, from a remote user device over a communication network, a first user input comprising a search topic;
collecting electronic information about the search topic from at least one remote electronic information source over the communication network;
packaging the collected information in discrete information containers; and
sending the discrete information containers to the remote user device for display.

2. The method of claim 1, further comprising receiving a set of filter parameters, and filtering the collected electronic information using the set of filter parameters prior to packaging it.

3. The method of claim 2, wherein the set of filter parameters comprises one or more of: search keywords, time, information sources, geographical location, social engagement, and relevance to the topic.

4. The method of claim 2, further comprising permanently storing the filtered electronic information in a database.

5. The method of claim 4, further comprising:
creating an empty notebook; and
organizing the filtered electronic information related to the topic in the notebook.

6. The method of claim 5, further comprising:
abbreviating the filtered electronic information of each information container in an information bubble thereby resulting in a list of information bubbles.

7. The method of claim 6, further comprising displaying the full content of the electronic information container upon detecting a pointing device clicking or moving over one of the information bubbles.

8. The method of claim 4, further comprising dividing a visual display of said notebook on a display device into at least two sections, one section defining a content stream including the filtered electronic information, and another section defining saved content that was selected from the content stream to be saved in the notebook.

9. The method of claim 8, further comprising dragging at least one of the content stream section and the saved content section into a website, whereby changes that occur in one of the sections in the notebook are reflected automatically in the website.

10. The method of claim 4, further comprising:
receiving newly collected information from the at least one information source;
filtering the newly collected electronic information to produce updated filtered information;
storing the updated filtered information in the database;
comparing the updated filtered information with information previously stored in the database to find electronic information duplicates; and
eliminating electronic information duplicates from the database.

11. The method of claim 6, wherein the filter parameters are received from one or more users in a collaborative environment, the users having access to a single pool of filtered electronic information, and having the authority to save information bubbles by selecting and saving portions of the filtered information.

12. The method of claim 11, wherein electronic information selected from the filtered electronic information and saved in the discrete information containers is removed from the filtered electronic information to avoid duplication of electronic information in the notebook.

13. The method of claim 6, wherein the filter parameters are received from one or more users in a collaborative environment, each user having the authority to set their own filter parameters and create their own information bubbles.

14. The method of claim 11, further comprising providing a dashboard including a notification of all activities representing user interactions in the notebook.

15. A system for managing electronic information, the system comprising:
an input adapted to receive, from a remote user device over a communication network, a first user input comprising a search topic;
a processor having access to statements and instructions which when executed cause the processor to collect electronic information about the search topic from at least one remote information source over the communication network;
a memory for packaging the collected electronic information in discrete information containers; and
an output for sending the discrete information containers to the remote user device for display.

16. The system of claim 15, wherein the system receives a set of filter parameters, and filters the collected electronic information using the set of filter parameters prior to packaging it.

17. The system of claim 15, wherein the system is adapted to create an empty notebook, abbreviate the filtered electronic information of each information container in an information bubble, and organize the filtered electronic information in the notebook as a list of information bubbles.

18. The system of claim 17, wherein the system displays the full content of the information container upon detecting a pointing device clicking or moving over the information bubble.

19. The system of claim 17, wherein the filter parameters are received from one or more users in a collaborative environment, the users having access to a single pool of filtered electronic information, and having the authority to create their own information bubble by selecting and saving portions of the filtered electronic information.

20. A method for managing electronic information, the method comprising:
receiving, from a remote user device over a communication network, a first user input comprising a search topic and a set of filter parameters;
collecting electronic information about the search topic from at least one remote electronic information source over the communication network;
filtering the collected information based on the set of filter parameters to produce filtered electronic information;
abbreviating the filtered electronic information and packaging the abbreviated information in information bubbles;
creating an electronic notebook and listing the information bubbles in the electronic notebook;
sending the electronic notebook to the remote user device for display.
